(19) United States
(12) Patent Application Publication
(10) Pub. No.: US 2011/0290602 A1
(43) Pub. Date: Dec. 1, 2011

(54) INTERCONNECTION FOR CAST-IN-PLACE COMPONENTS

(75) Inventors: Richard M. Kleber, Clarkston, MI (US); Michael D. Hanna, West Bloomfield, MI (US)

(73) Assignee: GM GLOBAL TECHNOLOGY OPERATIONS, INC., Detroit, MI (US)

(21) Appl. No.: 12/789,841

(22) Filed: May 28, 2010

(51) Int. Cl. F16D 65/12; B22D 19/04

(52) U.S. Cl. 188/218 XL; 164/111

(57) ABSTRACT

A first component may be made of a first material and may have a flange extending away from a body of the first component. The flange may have a groove located in an upper surface, a lower surface, or both the upper and lower surfaces of the flange. A second component may be made of a second material that may be different than the first material. The second component may have a portion located over a part or more of the flange and over the groove in order to form an interconnection between the first and second components. One of the first component or the second component being cast-in-place.

### TECHNICAL FIELD

The field to which the disclosure generally relates includes ways to join components of different materials, and ways to join components that are cast-in-place.

### BACKGROUND

Some components have separate and distinct portions of different materials that are joined together. The separate portions may be joined by a cast-in-place process in which one portion is cast over another portion to form a joint thereat.

### SUMMARY OF SELECT EMBODIMENTS OF THE INVENTION

One embodiment may include a product which itself may include a first component and a second component. The first component may comprise a first material and may have a flange. The flange may extend away from a body of the first component and may have a groove located in an upper surface, a lower surface, or both the upper and lower surfaces of the flange. The second component may comprise a second material that may be different than the first material. The second component may have a portion located over a part or more of the flange and over the groove in order to form an interconnection between the first and second components.

One embodiment may include a product which itself may include a brake rotor. The brake rotor may include a cheek and a hub. The cheek may comprise a first material and may have a first annular flange. The first annular flange may extend away from a body of the cheek and may extend radially inwardly toward an axis of rotation of the brake rotor. The first annular flange may have a groove located in an upper surface, in a lower surface, or in both the upper and lower surfaces of the first annular flange. The groove may extend around a part or more of a circumference of the first annular flange. The hub may comprise a second material that may be different than the first material. The hub may have a second annular flange that may be cast-in-place over a part or more of the first annular flange and over the groove in order to form an interconnection between the cheek and the hub.

One embodiment may include a method of making a product. The method may include providing a cheek of a brake rotor. The cheek may be comprised of a first material and may have a first annular flange. The first annular flange may extend away from a body of the cheek and may extend radially inwardly toward an axis of rotation of the brake rotor. A first annular flange may have multiple alternating projections and recesses extending circumferentially around the first annular flange. Some or more of the projections may have a groove located in an upper surface, a lower surface, or both the upper and lower surfaces of the projection. The method may also include placing the cheek in a first molding machine half. The method may further include bringing the first molding machine half and a second molding machine half together. The first and second molding machine halves may form a cavity constructed and arranged in the shape of a hub of a brake rotor. And the method may include filling the cavity with a molten second material that may be different than the first material. When solidified, the second material may form the hub of the brake rotor. The hub may have a second annular flange solidified over a part or more of the first annular flange and over the grooves in order to form an interconnection between the cheek and the hub.

Other embodiments of the invention will become apparent from the detailed description provided hereinafter. It should be understood that the detailed description and specific examples, while disclosing illustrative embodiments of the invention, are intended for purposes of illustration only and are not intended to limit the scope of the invention.

### BRIEF DESCRIPTION OF THE DRAWINGS

Illustrative embodiments of the invention will become more fully understood from the detailed description and the accompanying drawings, wherein:

FIG. 1 is a perspective view of one embodiment of a cheek of a brake rotor.

FIG. 2 is a perspective view of one embodiment of a brake rotor having the cheek of FIG. 1.

FIG. 3 is a sectioned and segmented view of the brake rotor of FIG. 2.

FIG. 4 is a sectioned and segmented view of the brake rotor of FIG. 2.

### DETAILED DESCRIPTION OF ILLUSTRATIVE EMBODIMENTS

The following description of the embodiment(s) is merely illustrative in nature and is in no way intended to limit the invention, its application, or uses.

The figures illustrate a component assembly, such as an automotive component like a brake rotor 10, that may be made in part by a cast-in-place process in which a first component of a first material is cast-over by a second component of a second material. The first and second components are joined at an interconnection that, in one or more embodiments, may be designed and constructed to provide a close fit between the first and second component which may constrain thermal expansion and contraction which can occur during use with fluctuations in temperature, while maintaining an effective mechanical joint at the interconnection. The interconnection described herein may be suitable for use with other automotive components including, but not limited to, a pulley assembly for an automotive accessory drive system, a brake drum, and a transmission gear.

Furthermore, as used herein, the terms axially, radially, and circumferentially refer to directions with respect to the generally circular and cylindrical shape of the brake rotor 10, so that the radial direction extends generally along any one of the imaginary radii of the shape, the axial direction is generally parallel to a center axis of the shape, and the circumferential direction extends generally along any one of the imaginary circumferences of the shape.

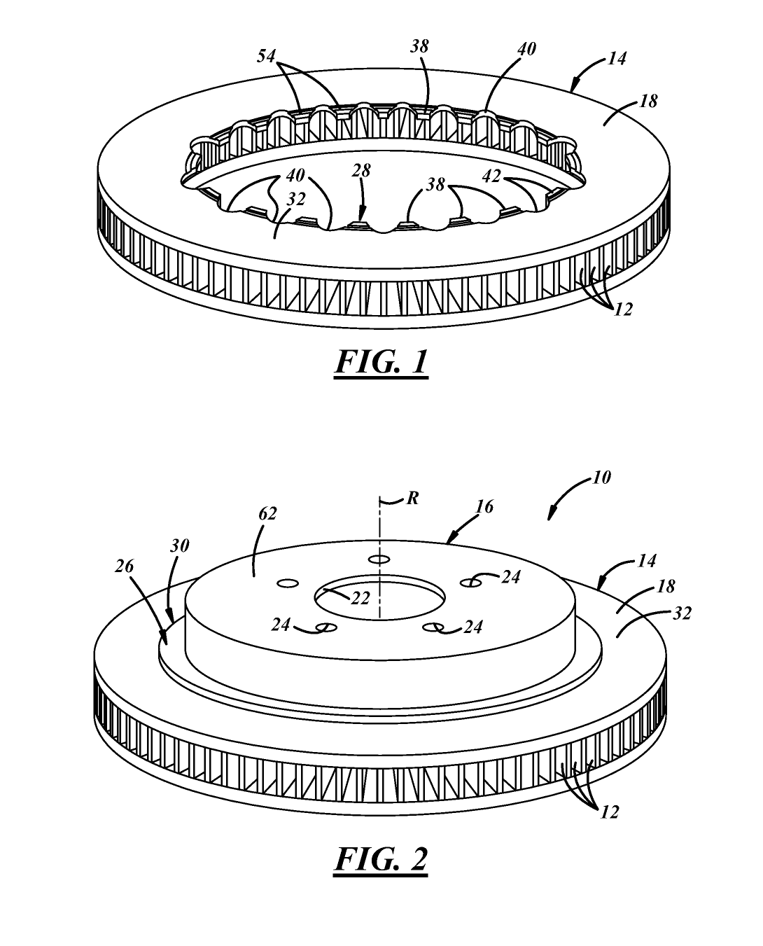

Referring to FIGS. 1-4, a brake rotor 10 may be of the vented-type having a number of vanes 12 as shown, may be of the solid-type (not shown), or may be another type. The brake rotor 10 may include a cheek 14 and a hub 16. The cheek 14 may include a first cheek face 18 and an oppositely located second cheek face 20 that together constitute braking or friction surfaces of the brake rotor 10 that come into contact with a braking pad (not shown) or another braking component during a braking event. The hub 16 may be used to mount the brake rotor 10 to an associated vehicle support, and may have a central aperture 22 and a number of bolt holes 24 to facilitate such mounting.

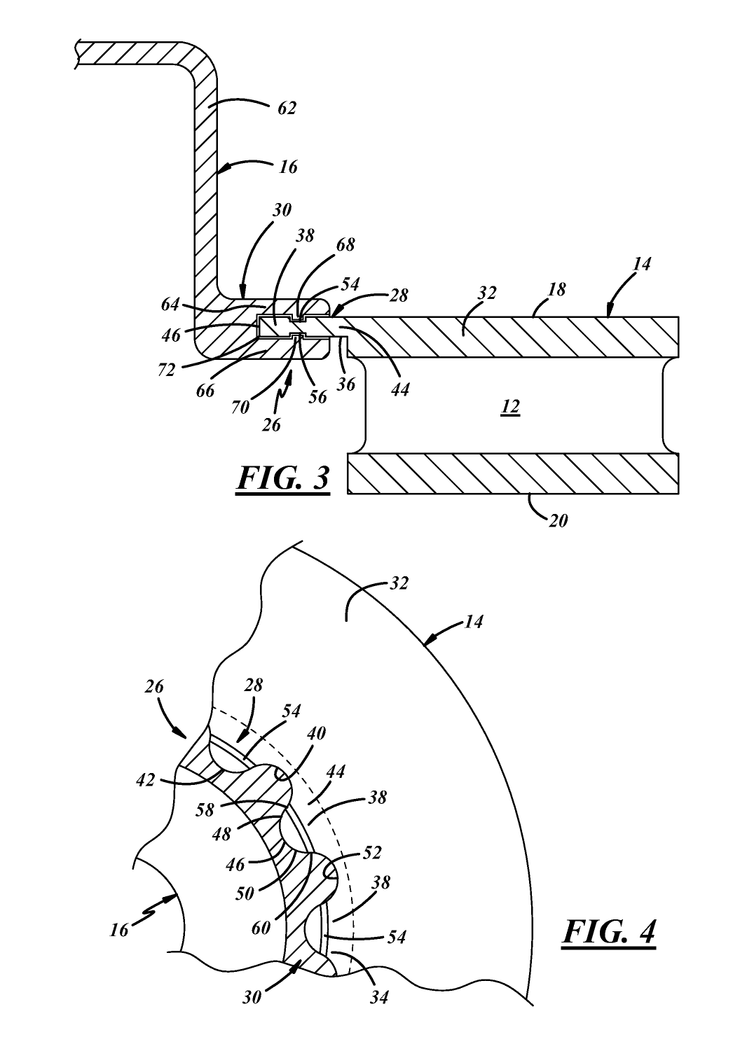

In one embodiment, the cheek 14 and the hub 16 may be made out of different materials to, among other things, reduce weight in the brake rotor 10. For example, the cheek 14 may be made out of a cast iron such as grey iron or steel, and the hub 16 may be made out of aluminum such as aluminum alloy 356 or magnesium such as a magnesium alloy. The cheek 14 and the hub 16 may be mechanically joined together by an interconnection 26 (best seen in FIG. 3) created by portions of the cheek and hub that are fitted together during the cast-in-place process, as will be described below in detail. In the embodiment shown, the interconnection 26 may be formed by a first flange 28 of the cheek 14 and by a second flange 30 of the hub 16. The interconnection 26 may secure the cheek 14 and the hub 16 together without the use of rivets or other mechanical fasteners, though in some cases mechanical fasteners may be used in addition to the interconnection.

The first flange 28 may extend from, and may be unitary with, a body 32 of the cheek 14. The first flange 28 may have a generally annular shape and may extend around an inner imaginary circumference of the cheek 14. The first flange 28 may be located at a radially inboard side of the cheek 14, and may protrude radially inwardly toward an axis of rotation R of the brake rotor 10. The first flange 28 may be located axially at the first cheek face 18 as shown, oppositely at the second cheek face 20 (not shown), or axially anywhere therebetween. The first flange 28 has an upper surface 34 which may be in the same plane as the first cheek face 18, and has a lower surface 36 which may be parallel to the upper surface. The first flange 28 may have the same axial thickness at its proximal end as at its distal or free end.

The first flange 28 may have multiple alternating projections 38 and recesses 40 located circumferentially therearound, and formed in part by a sinusoidal edge 42. The projections 38 are spaced apart from one another by the recesses 40, and likewise the recesses are spaced apart from one another by the projections. When viewed via a top view such as that shown in FIG. 4, each projection 38 may have the general shape of a rounded nose and each recess 40 may have the general shape of a rounded depression. The projections 38 and recesses 40 may not have sharp edges or square edges when viewed from the top as illustrated in FIG. 4. Each projection 38 may extend radially or longitudinally from a proximal end 44 at the body 32 to a distal or blunted free end 46. Each projection 38 may have a first side edge 48 and an oppositely located second side edge 50. Each recess 40 may have a bottom edge 52 that does not extend into the body 32, or at least does not interfere with a first cheek face 18 or the vanes 12.

Referring to FIGS. 3 and 4, each projection 38 may have a first groove 54 and a second groove 56 constructed and arranged to receive molten material of the hub 16 during the cast-in-place process in order to form, in part, the interconnection 26. The first groove 54 may be located in the upper surface 34, and the second groove 56 may be located in the lower surface 38 at the same point on an imaginary radius as the first groove. The first and second grooves 54, 56 may be located radially about midway in each projection 38. As shown in FIG. 3, the first and second grooves 54, 56 may have a generally rectangular cross-section, and may each have an axial depth that is less than one half the axial thickness of the respective projection 38. Though not shown, the first and second grooves 54, 56 may have a generally trapezoidal cross-section with angled walls, and may have a draft angle to facilitate a casting process. As shown best in FIG. 4, the first and second grooves 54, 56 may generally traverse the radial or longitudinal direction of the first flange 28 and of each projection 38, and may extend generally along an imaginary circumference of the first flange and continuously from the first side edge 48 to the second side edge 50. Each of the first and second grooves 54, 56 may have a first open end 58 and a second open end 60. In one sense, each first groove 54 may constitute a single continuous groove formed around the circumference of the first flange 28 that is segmented into individual grooves via the recesses 40, and likewise each second groove 56 may constitute a single continuous groove formed around the circumference of the first flange 28 that is segmented into individual grooves via the recesses.

Referring to FIGS. 2 and 3, once formed, the second flange 30 may entirely enclose the first flange 28 and may enclose all of the first and second grooves 54, 56. In other embodiments, second flange 30 need not necessarily enclose all of the first flange 28 or all of the first and second grooves 54, 56 in order to form a proper interconnection, and instead may enclose a portion of the first flange and some of the first and second grooves. The second flange 30 may protrude radially outwardly and away from a body 62 of the hub 16. The second flange 30 may have an upper second flange portion 64 that encloses the first grooves 54, and may have a lower second flange portion 66 that encloses the second groove 56. In other embodiments, the second flange 30 may be located and oriented differently on the hub 16 than shown, such as midway along the axial extent of the body 62.

One embodiment may include a method of making the brake rotor 10 may include several steps including a so-called cast-in-place process whereby the second flange 30 is cast-around the first flange 28. For example, the cheek 14 may be initially made by a casting process, a machining process, a forging process, a combination thereof, or another suitable metalworking process. The first flange 28, or select portions thereof, may be coated with a ceramic spray or other suitable material and/or process in order to help prevent a metallurgical bonding between the materials of the first flange and those of the second flange 30; this coating may also be used to control the thickness of a gap (subsequently discussed) that may develop at an interface of the first and second flanges. The cheek 14 may then be placed, manually or automatically, in a first cavity of a first molding machine half. The first cavity may resemble the shape of the cheek 14 and may also resemble the shape of a portion or more of the hub 16. In an example where cast iron is used as the material for the cheek 14, the cheek and the first cavity may be maintained at a temperature of about 850° F., or at another suitable temperature. Once placed in the first cavity, the first molding machine half and an opposing second molding machine half may be brought together under pressure and may be sealed to form a second cavity that may resemble the shape of the hub 16. The second cavity may then be filled, such as by an injection process, with a molten material such as a molten aluminum or a molten magnesium alloy. Upon cooling and solidification, the second flange 30 may envelope the first flange 28 and may envelope the first and second grooves 54, 56 in order to form the interconnection 26. The cheek 14 and the hub 16 are then thus mechanically joined so that the components do not substantially move or rotate relative to each other.

Furthermore, upon complete solidification, a first finger 68 extends into and is received in the first groove 54, and a second finger 70 is inserted into and received in the second groove 56. A slight gap 72 may be formed at the interconnection 26 as a result of the different temperatures of the different materials during formation and subsequent cooling. The gap 72 may develop at the interface of the first and second flanges 28, 30, and between the opposing and confronting surfaces of the first and second flanges. The gap 72 may not necessarily be present throughout the entire interface of the first and second flanges 28, 30. Furthermore, upon complete solidification, the material of the second flange 30 may undergo local shrinkage at the interface of the first and second flanges 28, 30. In some cases, this shrinkage could squeeze the first flange 28 and help maintain an effective mechanical joint between the cheek 14 and the hub 16 at the interface. For example, referring to FIG. 3, a radial squeezing force could exist on the first flange 28 between the first finger 68 of the second flange 30 and the free end 46 of the first flange. In a braking event during use, the cheek 14 and the hub 16 can become heated and can thermally expand as a response. Though the cheek 14 may become hotter in some cases, the particular material of the hub 16 (e.g., aluminum, magnesium, or an alloy thereof) may have a greater coefficient of thermal expansion and thus may expand to a similar extent or more than the cheek. Conversely, after use in cold weather, the cheek 14 and the hub 16 can become cooled and can thermally contract as a response. In each instance, the interconnection 26 may maintain an effective mechanical joint between the cheek 14 and the hub 16, and may not allow relative movement between the first and second flanges 28, 30. That is, the physical thermal expansion and contraction may be constrained by the interconnection 26. It is believed that ss a result, there may be some slight and unobservable deformation, or coning, at the interconnection 26 after use of the brake rotor 10. The brake rotor 10 may be designed and constructed to tolerate some degree of coning, while still being effective in use.

The particular construction and arrangement of the first and second flanges 28, 30—including the dimensions, locations, shapes, or a combination thereof—may individually or collectively provided a close fit at the interconnection 26 that locks the cheek 14 and the hub 16 together for maintaining an effective mechanical joint at the interconnection. The close fit may be maintained even during thermal expansion, contraction, or both at the interconnection 26. The close fit may facilitate heat transfer between the cheek 14 and the hub 16.

In different embodiments, the brake rotor 10 and the interconnection 26 may have different constructions and arrangements than shown and described. For example, the first flange may not be formed with the projections and recesses; the interconnection could only include the first grooves or could only include the second grooves; the first grooves may not be located on all of the projections, the second grooves may not be located on all of the projections, or a combination thereof; and the first and second grooves need not necessarily be aligned with an imaginary circumference of the brake rotor.

The above description of embodiments of the invention is merely illustrative in nature and, thus, variations thereof are not to be regarded as a departure from the spirit and scope of the invention.

What is claimed is:

1. A product comprising:
a first component comprising a first material and having a flange extending away from a body of the first component, the flange having a groove located in at least one of an upper surface or a lower surface of the flange; and
a second component comprising a second material different than the first material, the second component having a portion located over at least part of the flange and over the groove to form an interconnection between the first and second components, and wherein one of the first component or the second component is cast-in-place.

2. A product as set forth in claim 1 wherein the flange has a plurality of alternating projections and recesses extending therearound, and wherein the groove is located in each of the projections.

3. A product as set forth in claim 2 wherein each projection extends longitudinally from a proximal end at the body to a distal end at a free end of the projection, and each groove traverses the longitudinal direction of the projection and extends continuously from a first side edge of the projection to a second side edge of the projection.

4. A product as set forth in claim 1 wherein the flange extends longitudinally from a proximal end at the body to a distal end at a free end of the flange, and wherein the groove traverses the longitudinal direction of the flange.

5. A product as set forth in claim 1 wherein the groove includes a first groove located in the upper surface of the flange and includes a second groove located in the lower surface of the flange, wherein the portion of the second component is cast-in-place over the first and second grooves to form the interconnection between the first and second components.

6. A product as set forth in claim 1 wherein the first component is a cheek of a brake rotor and the second component is a hub of the brake rotor.

7. A product as set forth in claim 1 wherein the first material comprises a cast iron and the second material comprises at least one of aluminum or magnesium.

8. A product comprising:
a brake rotor comprising:
a cheek comprising a first material and having a first annular flange extending away from a body of the cheek and radially inwardly toward an axis of rotation of the brake rotor, the first annular flange having a groove located in at least one of an upper surface or a lower surface of the first annular flange and the groove generally extending at least part way around a circumference of the first annular flange; and
a hub comprising a second material different than the first material, the hub having a second annular flange cast-in-place over at least part of the first annular flange and over and into the groove to form an interconnection between the cheek and the hub.

9. A product as set forth in claim 8 wherein the first annular flange has a plurality of alternating projections and recesses extending circumferentially therearound and formed in part by a sinusoidal edge of the first annular flange, and wherein the groove is located in each of the projections.

10. A product as set forth in claim 9 wherein each projection extends radially from a proximal end at the body to a distal end at a free end of the projection, and each groove traverses the radial direction of the projection and extends continuously from a first side edge of the projection to a second side edge of the projection.

11. A product as set forth in claim 8 wherein the groove includes a first groove located in the upper surface of the first annular flange and includes a second groove located in the lower surface of the first annular flange, wherein the first and second grooves generally extend at least part way around the circumference of the first annular flange, and wherein the second annular flange is cast-in-place over and into the first and second grooves to form the interconnection between the cheek and the hub.

12. A product as set forth in claim 8 wherein the first material comprises a cast iron and the second material comprises at least one of aluminum or magnesium.

13. A method of making a product, the method comprising:
providing a cheek of a brake rotor, the cheek being comprised of a first material and having a first annular flange extending away from a body of the cheek and extending radially inwardly toward an axis of rotation of the brake rotor, the first annular flange having a plurality of alternating projections and recesses extending circumferentially therearound, at least some of the projections having a groove located in at least one of an upper surface or a lower surface of the projection;
placing the cheek in a first molding machine half;
bringing the first molding machine half and a second molding machine half together, the first and second molding machine halves forming a cavity constructed and arranged in the shape of a hub of a brake rotor; and
filling the cavity with a molten second material different than the first material, wherein, when solidified, the second material forms the hub of the brake rotor, the hub having a second annular flange solidified over at least part of the first annular flange and over and into the grooves to form an interconnection between the cheek and the hub.

14. A method as set forth in claim 13 wherein each projection extends radially from a proximal end at the body to a distal end at a free end of the projection, and each groove traverses the radial direction of the projection and extends continuously from a first side edge of the projection to a second side edge of the projection.

15. A method as set forth in claim 13 wherein each groove includes a first groove located in the upper surface of the projection and includes a second groove located in the lower surface of the projection, and wherein the second annular flange is solidified over and into the first and second grooves to form the interconnection between the cheek and the hub.

16. A method as set forth in claim 13 wherein the first material comprises a cast iron and the second material comprises at least one of aluminum or magnesium.

17. A product as set forth in claim 1 wherein the first component is a brake rotor hub or a brake rotor cheek.

18. A product as set forth in claim 1 wherein the second component is a brake rotor hub or a brake rotor cheek.
